(19) United States
(12) Patent Application Publication
(10) Pub. No.: US 2011/0216840 A1
(43) Pub. Date: Sep. 8, 2011

(54) SIGNAL TRANSMISSION METHOD AND SIGNAL RECEIVING METHOD IN A MULTI-INPUT MULTI-OUTPUT SYSTEM

(76) Inventors: Moon Il Lee, Gyeonggi-do (KR); Wook Bong Lee, Gyeonggi-do (KR); Bin Chul Ihm, Gyeonggi-do (KR); Jin Young Chun, Gyeonggi-do (KR)

(21) Appl. No.: 13/127,441

(22) PCT Filed: Nov. 4, 2009
(86) PCT No.: PCT/KR2009/006446

§ 371 Date: May 3, 2011

Related U.S. Application Data
(60) Provisional application No. 61/113,586, filed on Nov. 11, 2008.

(30) Foreign Application Priority Data
May 15, 2009 (KR) 10-2009-0042701

(51) Int. Cl. H04L 27/00

(52) U.S. Cl. 375/259

(57) ABSTRACT

Disclosed is a signal transmission method comprising a feedback information receiving step of receiving a transmission rate and channel state information for transmission from a receiving end, a step of generating a signal to be transmitted by using a multi-antenna in accordance with the transmission rate, a step of performing a precoding on the generated signal by using the precoding matrix of the nested structure selected from a predetermined codebook in accordance with the transmission rate, and a step of transmitting the precoded signal. Said codebook includes a precoding matrix set in which a pre-coding matrix according to a first number of streams is not included in a precoding matrix according to a second number of streams greater than the first number of streams.

### TECHNICAL FIELD

The following description relates to a signal transmission method in a multi-input multi-output (MIMO) system using a codebook which includes a precoding matrix set having a structure in which a precoding matrix according to a specific number of streams is included in a precoding matrix according to a greater number of streams and includes a precoding matrix set comprised of precoding matrices exhibiting optimal performance according to the number of streams although it does not have the above structure.

### BACKGROUND ART

Recently, with the popularization of information communication services, the emergence of various multimedia services, and the provision of high-quality services, demand for high speed wireless communication services has rapidly increased. To actively cope with such demand, communication system capacity should be increased. To increase communication capacity in wireless communication environments, a method for searching new available frequency bands and a method for increasing efficiency in limited resources may be considered. As to the latter, a MIMO transmission/reception technique, in which a diversity gain is obtained by equipping a transmitter and a receiver with a plurality of antennas to additionally ensure a spatial region for utilizing resources, or transmission capacity is increased by transmitting data in parallel through the plurality of antennas, has recently drawn attention and has been actively developed.

In brief, MIMO, an abbreviation of ‘Multi-Input Multi-Output’, refers to a method of improving data transmission/reception efficiency using multiple transmission antennas and multiple reception antennas, as opposed to a conventional method employing one transmission antenna and one reception antenna. That is, MIMO is a technology utilizing multiple antennas in a transmitter or a receiver of a wireless communication system to increase capacity or improve performance. Hereinbelow, MIMO is referred to as multiple antennas.

In summary, multiple antenna technology is an application of techniques for restoring data by collecting pieces of data received through several antennas, without depending on a single antenna path, in order to receive a single message. Through multiple antenna technology, data transmission rate can be improved in a specific range or a system range can be increased at a specific data transmission rate.

Since next-generation mobile communication requires much higher data transmission rates than conventional mobile communication, efficient multiple antenna technology is expected to be necessarily needed. In such a circumstance, a MIMO communication technology is a next-generation mobile communication technology which can be widely applied to mobile communication terminals, relays, etc. and is drawing attention as a technology to increase mobile communication transmission capacity which has reached the limits due to expansion of data communication.

Meanwhile, MIMO technology using multiple antennas both in a transmitter and a receiver among a variety of currently studied technologies for transmission efficiency improvement has received attention as a method which can remarkably improve communication capacity and transmission/reception performance without additional frequency allocation or power increase.

MIMO technology increases channel capacity within limited frequency resources by using a plurality of antennas. By using a plurality of antennas, MIMO technology provides channel capacity which is proportional to, in theory, the number of the antennas in rich scattering environments.

FIG. 1 is a configuration diagram of a general MIMO communication system.

As shown in FIG. 1, if the numbers of transmission antennas and reception antennas are simultaneously increased to N_{T} and N_{R}, respectively, theoretical channel transmission capacity is increased in proportion to the number of antennas, unlike the case where only either a transmitter or a receiver uses a plurality of antennas. Accordingly, it is possible to increase transmission rate and to remarkably improve frequency efficiency. Theoretically, transmission rate according to an increase in channel transmission capacity can be increased by a value obtained by multiplying an increased rate Rᵢ indicated in the following equation by a maximum transmission rate Rₒ in case of using one antenna.

Rᵢ=min(N_{T},N_{R}) [Equation 1]

For example, in a MIMO communication system using four transmission antennas and four reception antennas, it is possible to theoretically obtain a transmission rate which is four times a transmission rate of a single antenna system.

After an increase in the theoretical capacity of the MIMO system was first proved in the mid-1990s, various techniques for substantially improving data transmission rate have been actively developed. Several of these techniques have already been incorporated into a variety of wireless communication standards including the 3^{rd} generation mobile communication and the next-generation wireless local area networks.

Active research up to now related to the MIMO technology has focused upon a number of different aspects, including research into information theory related to the computation of MIMO communication capacity in various channel environments and in multiple access environments, research into wireless channel measurement and model derivation of MIMO systems, and research into space-time signal processing technologies for improving transmission reliability and transmission rate.

Transmission signals may be considered with respect to the case where spatial diversity is used and the case where spatial multiplexing is used.

When spatial multiplexing is used, since different signals are multiplexed for transmission, elements of an information vector S have different values. However, when spatial diversity is used, since the same signal is transmitted through the same channel path, elements of the information vector S have the same value.

A hybrid scheme of spatial multiplexing and spatial diversity may also be considered. For example, the same signal may be transmitted through some transmission antennas using spatial diversity and different signals may be transmitted through the other transmission antennas using spatial multiplexing.

Generally, a rank of a matrix is defined as a minimum number among the number of rows or columns which are independent. Accordingly, a rank of a matrix cannot be greater than the number of rows or columns.

Each of different information transmitted using a MIMO technology is defined as a ‘transmission stream’ or simply a ‘stream’. Such a ‘stream’ may be referred to as a ‘layer’. Then the number of transmission streams cannot be greater than a channel rank which is a maximum number of different information which can be transmitted.

Here, one stream can be transmitted through one or more antennas. There are various methods to map one or more streams to multiple antennas. According to types of MIMO technologies, the case where one stream is transmitted through multiple antennas may be considered a spatial diversity scheme and the case where multiple streams are transmitted through multiple antennas may be considered a spatial multiplexing scheme.

A transmission diversity scheme is a technology for raising the reliability of received signals even though a part of channel is inferior. The transmission diversity scheme is mainly used when a user terminal is located at a cell edge, and may be used when scheduling according to channels is difficult to be performed due to rapid channel variation or when channels are changed. In addition, there may be other circumstances and conditions under which the transmission diversity scheme can be used.

Generally, since a diversity scheme requires pilots for channel estimation corresponding to the number of antennas, it is problematic in that pilot overhead is increased.

### DISCLOSURE

### Technical Problem

An object of the present invention is to provide a transmission diversity method which can improve diversity gain and reduce pilot overhead by selecting a column vector of precoding matrices according to the number of streams, wherein a precoding matrix according to a first number of streams includes a column matrix of a precoding matrix according to a second number of streams which is greater than the first number of streams.

### Technical Solution

In an aspect of the present invention, provided herein a signal transmission method of a transmitter using multiple antennas, including a feedback information receiving step of receiving a transmission rate for signal transmission and channel state information from a receiver, a step of generating a signal to be transmitted using the multiple antennas according to the transmission rate, a step of performing precoding upon the generated signal using a precoding matrix of a nested structure selected from a predetermined codebook according to the transmission rate, and a step of transmitting the precoded signal, wherein the codebook includes a precoding matrix set in which a precoding matrix according to a first number of streams is not included in a precoding matrix according to a second number of streams which is greater than the first number of streams. The feedback information receiving step may include receiving feedback information further including the number of streams and channel quality information from the receiver. The number of the streams may be determined by the transmission rate, and when the transmission rate is 1, the transmission rate may be equal to the number of the streams.

The precoding matrix of the nested structure may be a precoding matrix in which a precoding matrix according to a first number of streams is included in a precoding matrix according to a second number of streams which is greater than the first number of streams.

The transmitter may be a terminal and the receiver may be a base station, or the transmitter may be a base station and the receiver may be a terminal.

In another aspect of the present invention, provided herein is a signal reception method of a receiver in a multiple antenna system, including a step of estimating channel information of a reception signal, a feedback information transmitting step of transmitting a transmission rate for signal transmission and channel state information, based on the channel information of the reception signal to a transmitter, and a step of receiving a precoded signal using the transmission rate and precoding matrix information of a nested structure corresponding to the number of streams in a predetermined codebook, wherein the codebook includes a precoding matrix set in which a precoding matrix according to a first number of streams is not included in a precoding matrix according to a second number of streams which is greater than the first number of streams.

The feedback information transmitting step may include transmitting feedback information further including the number of streams and channel quality information to the transmitter. The number of the streams may be determined by the transmission rate, and when the transmission rate is 1, the transmission rate may be equal to the number of the streams.

A precoding matrix of the nested structure may be a precoding matrix in which a precoding matrix according to a first number of streams is included in a precoding matrix according to a second number of streams which is greater than the first number of streams. A precoding matrix of the nested structure may be configured by selecting a column vector corresponding to the received number of streams from a precoding matrix based on the feedback information from the transmitter.

The transmitter may be a terminal and the receiver may be a base station, or the transmitter may be a base station and the receiver may be a terminal.

The technical solutions of the present invention are not limited to the above-mentioned technical solutions, and other technical solutions not mentioned above can be clearly understood by one skilled in the art from the following description.

### Advantageous Effects

According to the above aspects of the present invention, if a nested structure in which a precoding matrix for a less number of streams is included in a precoding matrix for a greater number of streams is satisfied, it is convenient to calculate channel quality information or a plurality of users can share pilots.

The effects of the present invention are not limited to the above-mentioned effects, and other effects not mentioned above can be clearly understood by one skilled in the art from the following description.

### BRIEF DESCRIPTION OF DRAWINGS

FIG. 1 is a configuration diagram of a general MIMO communication system;

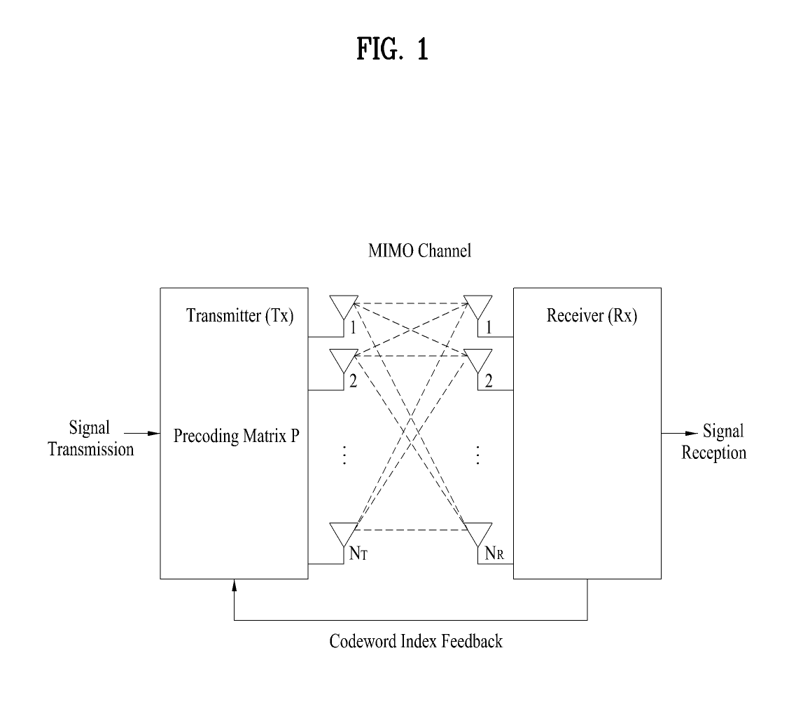

FIG. 2 is a diagram schematically illustrating signal transmission flow according to an embodiment of the present invention; and

FIG. 3 is a diagram illustrating a structure of a transmitter of a MIMO system according to an embodiment of the present invention.

### MODE FOR INVENTION

Hereinafter, exemplary embodiments of the present invention will be described with reference to the accompanying drawings. It is to be understood that the detailed description, which will be disclosed along with the accompanying drawings, is intended to describe the exemplary embodiments of the present invention and is not intended to describe a unique embodiment through which the present invention can be carried out.

For instance, although a detailed example applied to a 3^{rd} generation partnership project long term evolution (3GPP LTE) system is described hereinbelow, the present invention is applicable not only to the 3GPP LTE system but also to any wireless communication systems using a general multiple antenna system by the same principle. In the following description, the term base station may be replaced with other terms such as ‘Node B’, ‘eNode B’, etc., and the term terminal may be replaced with terms such as ‘user equipment (UE)’, ‘mobile station (MS)’, etc. A communication system is widely deployed to provide a variety of communication services such as voice, packet data, etc. The technology may be used in downlink or uplink. Downlink refers to communication from a base station to a terminal and uplink refers to communication from the terminal to the base station.

The following detailed description includes specific details in order to provide a thorough understanding of the present invention. However, it will be apparent to those skilled in the art that the present invention may be practiced without such specific details. In some instances, known structures and/or devices are omitted or are shown in block diagram form focusing on important features of the structures and/or devices, so as not to obscure the concept of the present invention. The same reference numbers will be used throughout this specification to refer to the same or like parts.

The present invention efficiently utilizes resources in time, frequency, and space regions in order to maximize throughput and/or coverage.

Performance loss in throughput may be generated as a result of deficiency of channel state information and/or large dependency on quality of the channel state information. To discuss a performance loss problem, a combined transmission diversity scheme based on encoding (i.e. space-time coding (STC)) is described.

In addition to STC, the coding techniques include space-time block code (STBC), non-orthogonal STBC, space-time trellis coding (STTC), space-frequency block code (SFBC), space-time frequency block code (STFBC), cyclic shift diversity, cyclic delay diversity (CDD), Alamouti, and precoding.

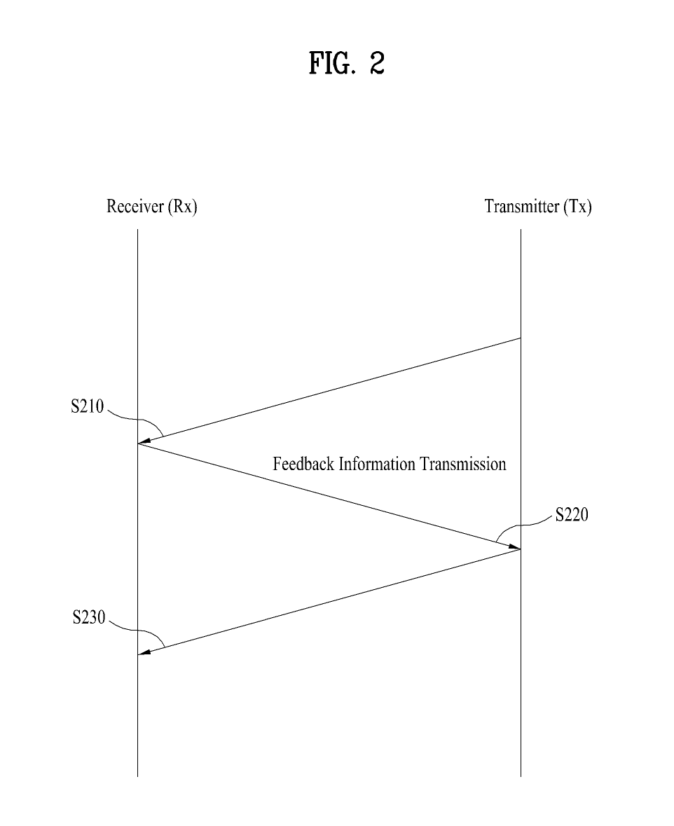

FIG. 2 is a diagram schematically illustrating a signal transmission flow according to an embodiment of the present invention.

Referring to FIG. 2, a transmitter transmits a feedback request to a receiver (step S210) and receives a transmission rate and channel state information (CSI), which are used for signal transmission, from the receiver which has received the feedback request. For example, the receiver may transmit the transmission rate and CSI to the transmitter at the same interval as one feedback information or may transmit respective feedback information to the transmitter at different intervals (step S220).

The above process may be a feedback information receiving step and in this step (S220) the transmitter may receive feedback information further including the number of streams and channel quality information (CQI) from the receiver. The number of streams may be determined according to the transmission rate R. If the transmission rate R is 1, the transmission rate R is equal to the number of streams.

The transmitter which received the feedback information generates a transmission signal, which is to be transmitted using multiple antennas, according to the transmission rate or the number of streams. The transmitter selects a precoding matrix from a predetermined codebook according to precoding matrix information and information about the received transmission rate or the number of streams, thereby performing precoding upon the generated signal.

Here, the codebooks include a ‘first type precoding matrix set’ used in a closed loop where a receiver transmits a precoding matrix index and a ‘second type precoding matrix set’ used in an open-loop where a receiver does not transmits a precoding matrix index and a predetermined codebook is used between a transmitter and the receiver.

In this case, the ‘first type precoding matrix set’ is desirably a precoding matrix set which is configured so that an optimized precoding matrix may selected according to the number of streams and has a form in which a precoding matrix according to a specific number of streams may not be included in a precoding matrix according to a different number of streams. The ‘second type precoding matrix set’ is proposed as a precoding matrix set satisfying a nested structure of a form in which a precoding matrix according to a specific number of streams is included in a precoding matrix according to the number of streams which is greater than the specific number of streams, so that calculation amount may be reduced upon calculating Channel Quality Information (CQI) or a plurality of users may share pilots.

Alternatively, in an aspect of the embodiment, the receiver may transmit, to the transmitter, signaling information for distinguishing between the first type precoding matrix set and the second type precoding matrix or selecting an open-loop or closed-loop mode to be used, and the transmitter may be configured to distinguish between the first type precoding matrix set and the second type precoding matrix set based on received signaling information. That is, signaling for distinguishing between a first mode using the first type precoding matrix set and a second mode using the second type precoding matrix set may be used.

Next, the precoded transmission signal may be transmitted to the receiver (step S230).

A structure of the transmitter in a MIMO system is described in more detail.

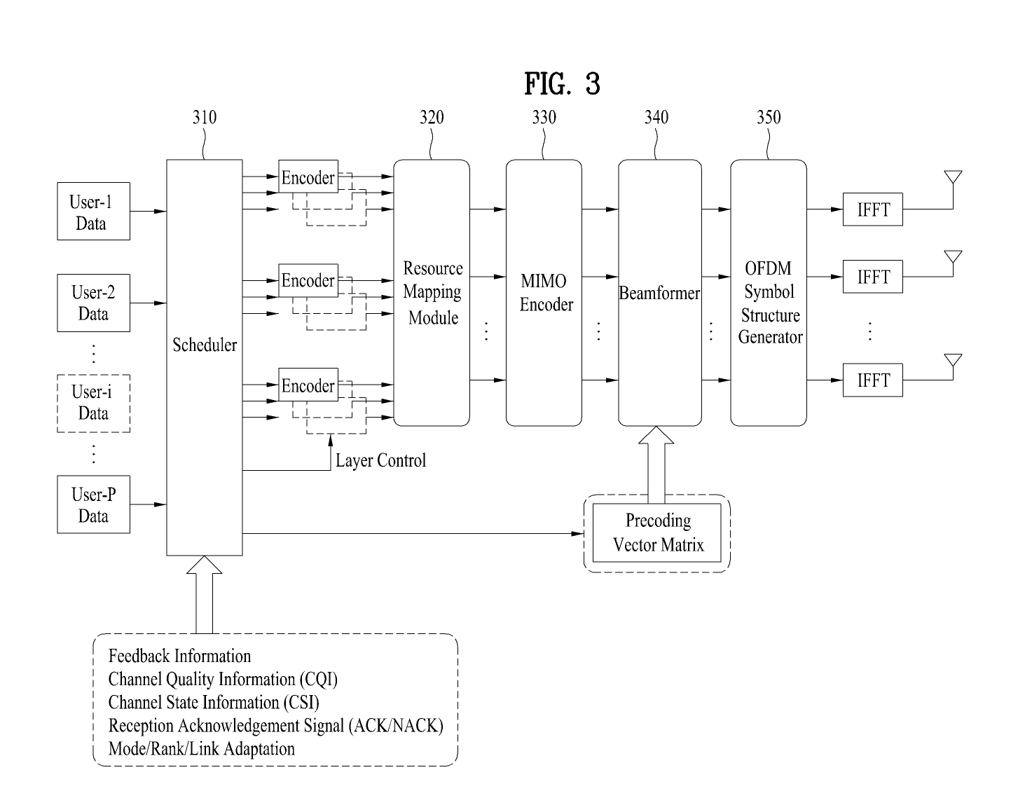

FIG. 3 is a diagram illustrating a structure of a transmitter of a MIMO system according to an embodiment of the present invention.

Referring to FIG. 3, the MIMO system may be generally comprised of a MIMO encoder and a precoder. If data information of each of a plurality of users, which is to be transmitted using a plurality of antennas, is input to a scheduler 310, the data information may be divided into a plurality of data streams by a serial-to-parallel (S/P) converter and may be transmitted to each of a plurality of encoders. Data streams after an encoding process are processed by a resource mapping module 320 and are then input to a MIMO encoder 330. The MIMO encoder 330 calculates the product of transmitted data streams of which dimension is M×1 and an encoding matrix. Thereafter, transmission symbols multiplexed by the encoder 330 are input to a beamformer 340 where the input transmission symbols are multiplied by precoding matrix vectors transmitted from the scheduler 310. The MIMO encoder 330 is a batch processor which simultaneously performs encoding with respect to M input symbols. An input signal in the MIMO encoder 330 is expressed by an (M×1) vector. The signals precoded in the beamformer pass through an OFDM symbol structure generator 350 to generate transmission signals. Signal streams are transmitted through antennas after passing through IFFTs. Meanwhile, in addition to precoding matrix information, feedback information including CQI, Channel State Information (CSI), ACK/NACK, and information about each mode/rank/link adaptation may be transmitted to the scheduler 310 simultaneously or individually.

Equation 2 denotes an input symbol transmitted to the encoder.

X=[S₁S₂ . . . Sᵢ . . . S_{M}]^{T} [Equation 2]

Equation 2 represents an (M×1) matrix consisting of data symbols transmitted to the encoder wherein Sᵢ denotes an input symbol of index i within a batch and M denotes the number of data which is simultaneously processed by the MIMO encoder 330. The data comprised of input symbols is multiplexed in the MIMO encoder and modulation symbols passing though the MIMO encoder are input to a precoder. In this case, an input vector X output from the MIMO encoder may be expressed as an (N_{S}×N_{F}) MIMO STC matrix Z=S(X) in case of STC. N_{S} denotes the number of streams and N_{F} denotes the number of subcarriers used to transmit a MIMO signal derived from the input vector X. A precoding matrix P of the precoder is N_{T}×N_{S}. Modulation symbols passing through the precoder may be expressed as a matrix N_{T}×N_{F} shown in Equation 3 in which N_{T} denotes the number of antennas.

$$y = P \times z = [ \begin{matrix}{y}_{1 , 1} & {y}_{1 , 2} & … & {y}_{1 , {N}_{F}} \\ {y}_{2 , 1} & {y}_{2 , 2} & … & {y}_{2 , {N}_{F}} \\ ⋮ & ⋮ & ⋱ & ⋮ \\ {y}_{{N}_{T} , 1} & {y}_{{N}_{T} , 2} & … & {y}_{{N}_{T} , {N}_{F}}\end{matrix} ] \qquad [ Equation 3 ]$$

In Equation 3, y_{j,k} denotes an output symbol being transmitted on a k-th subcarrier through a j-th transmission antenna, j denotes a transmission antenna index, and k may be a subcarrier index, a resource index, or an index of a subcarrier group.

Meanwhile, according to an aspect of the embodiment, a precoding matrix P may be selected from a first precoding matrix set or a second precoding matrix set. To this end, the transmitter may receive signaling information for distinguishing between a first mode using the first precoding matrix set and a second mode using the second precoding matrix set from the receiver. Furthermore, when transmitting feedback information to the transmitter, the receiver may transmit, to the transmitter, signaling information as to which set of the first precoding matrix set and the second precoding matrix set within a codebook is to be used or which mode of the first mode and the second mode is to be used.

The second precoding matrix set may be derived from the first precoding matrix set as shown in the following equation.

V₂(N_{T},N_{S},i₂)=V₂(N_{T},NₜN_{S},i₁) [Equation 4]

Here, N_{T} denotes the number of transmission antennas, Nₜ denotes the maximum number of streams, N_{S} denotes the number of streams, i₁ denotes a precoding matrix index in a first precoding matrix set, and i₂ denotes a precoding matrix index in a second precoding matrix set. Referring to FIG. 2, the total number N_{T} of transmission antennas, the maximum number Nₜ of streams in the codebook, and the number N_{S} of streams may be included in the feedback information transmitted by the receiver. V₁(N_{T}, Nₜ, N_{S}, i₁) denotes a matrix formed from a first precoding matrix. A transmitter having N_{T} transmission antennas may configure a second precoding matrix V₂ by selecting N_{S} column vectors from an i₁-th precoding matrix N_{T}×Nₜ for Nₜ streams. V₂(N_{T}, N_{S}, i₂) is the second precoding matrix and denotes an i₂-th precoding matrix N_{T}×N_{S} for N_{S} streams. Nₜ is not an indispensable element and may be replaced with other information. In this case, it is desirable that precoding column vectors corresponding to the number of streams are selected from a codebook such that the second precoding matrix set satisfies a nested structure in which a precoder matrix of a less number of streams is included in a precoder matrix of a greater number of streams. Thus, calculation amount can be reduced during calculation of CQI or pilots of a plurality of users can be shared.

More specifically, when a given subcarrier index is k, the precoding matrix P may satisfy Equation 5.

Gᵢ₁=W(k) [Equation 5]

W(k) denotes an (N_{T}×N_{S}) matrix selected from a preset unitary codebook and changes all u subcarriers and/or v OFDM symbols. The codebook is a unitary codebook, each matrix of which is comprised of a column of a unitary matrix.

The codebook may be a second type precoding matrix set having a form in which a precoding matrix according to a first number of streams is included in a precoding matrix according to a second number of streams greater than the first number of streams.

That is, when an iₜ-th matrix among matrices of a maximum rank of a first precoding matrix is Ci₁=[W₁ W₂ W₃ W₄], a precoding matrix in the case where the number of streams is is configured by selecting one column vector from a codebook and is indicated in Equation 6 by way of example.

Cᵢ₁=[W₁] [Equation 6]

If the number of streams is 2, a precoding matrix is configured by selecting two column vectors including the above column vector selected when the number of streams is 1 from the matrix Ci₁ and is indicated in Equation 7 by way of example.

Cᵢ₁=[W₁W₂] [Equation 7]

If the number of streams is 3, a precoding matrix is configured by select three column vectors including the above column vectors selected when the number of streams is 2 from the matrix Ci₁ and is indicated in Equation 8 by way of example.

Cᵢ₁=[W₁W₂W₃] [Equation 8]

If the number of streams is 4, a precoding matrix is configured by selecting four column vectors including the above column vectors selected when the number of streams is 3 from the matrix Ci₁ and is indicated in Equation 9 by way of example.

Cᵢ₁=[W₁W₂W₃W₄] [Equation 9]

In this way, precoding matrices corresponding to the number of data streams are selected from a precoding matrix codebook, and a column matrix of the first data stream precoder matrix is included in the second data stream precoding matrix which is greater in number than the first data streams. A second mode is configured by applying such a second type precoding matrix set. Since calculation amount can be reduced during calculation of CQI or multiple users can share pilots, convenience is increased.

Instead of obtaining a precoding matrix W from codebook elements with respect to each number of streams, a transmission diversity scheme is configured as indicated in Equation 6 to Equation 9 when one element of a codebook with respect to four streams for four transmission antennas in IEEE 802.16e is Ci₁.

A transmission mode may be variously configured.

According to an embodiment of the present invention, the number N_{T} of antennas and the transmission rate R are supported in an open-loop single user (SU)-MIMO system. A transmission diversity mode is defined when the transmission rate R is 1 and the number of antennas is 2Tx, 4Tx, and 8Tx during transmission.

Other space-multiplexing (SM) modes include modes when the transmission rate R is 2 and the number of antennas is 2Tx, 4Tx, and 8Tx, when the transmission rate R is 3 and the number of antennas is 4Tx and 8Tx, when the transmission rate R is 4 and the number of antennas is 4Tx and 8Tx, and when the transmission rate R is 8 and the number of antennas is 8Tx.

Meanwhile, in a transmission diversity mode when M=1, an input symbol of a MIMO encoder may be x=s₁ and an output of the MIMO encoder may be a scalar z=x. The output of the MIMO encoder is multiplexed by an (N_{T}×1) matrix W.

In the transmission diversity mode when M=2, an input of the MIMO encoder is expressed by a (2×1) vector as represented in Equation 10.

$$X = [ \begin{matrix}{S}_{1} \\ {S}_{2}\end{matrix} ] \qquad [ Equation 10 ]$$

The MIMO encoder performs an SFBC encoding matrix and has an output represented in Equation 11 which is multiplied by an (N_{T}×2) matrix W.

$$z = [ \begin{matrix}{S}_{1} & - {S}_{2}^{*} \\ {S}_{2} & {S}_{1}^{*}\end{matrix} ] \qquad [ Equation 11 ]$$

Each stream is transmitted to a matrix block and the matrix block applies different matrices according to the number of antennas and the transmission rate R.

Another embodiment of the present invention is associated with a method for generating a data stream by applying SM when the transmission rate is 2 or more.

For example, an SM mode in precoding includes modes when the transmission rate R is 2 and the number of antennas is 2Tx, 4Tx, and 8Tx, when the transmission rate R is 3 and the number of antennas is 4Tx and 8Tx, when the transmission rate R is 4 and the number of antennas is 4Tx and 8Tx, when the transmission rate R is 5 and the number of antennas is 8Tx, when the transmission rate R is 6 and the number of antennas is 8Tx, when the transmission rate R is 7 and the number of antennas is 8Tx, and when the transmission rate R is 8 and the number of antennas is 8Tx.

Meanwhile, when the number of rows of a rank according to all streams simultaneously transmitted is also M, an input and output of the MIMO encoder with respect to an SM mode of the transmission rate R is expressed as an (Rxl) vector as represented by Equation 12.

$$X = Z = [ \begin{matrix}{S}_{1} \\ {S}_{2} \\ ⋮ \\ {S}_{R}\end{matrix} ] \qquad [ Equation 12 ]$$

An output of the MIMO encoder is multiplexed by an (N_{T}×R) matrix W.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

As still another embodiment of the present invention, a terminal and a base station (FBS, MBS) which can implement the above-described embodiments will be described.

A terminal may operate as a transmitter in uplink and operate as a receiver in downlink. A base station may operate as a receiver in uplink and operate as a transmitter in downlink. Namely, the terminal and the base station may include the transmitter and receiver to transmit information or data.

The transmitter and receiver may include a processor, a module, a part, and/or a means to implement the embodiments of the present invention. Especially, the transmitter and receiver may include a module (means) for encrypting messages, a module for interpreting the encrypted messages, an antenna for transmitting and receiving messages, and the like.

The terminal used in the embodiments of the present invention may include a low-power radio frequency (RF)/intermediate frequency (IF) module. The terminal may also include a means, a module, or a part for performing a control function to implement the embodiments of the present invention, a medium access control (MAC) frame variable control function according to service properties and propagation environments, a handover function, an authentication and encryption function, a packet modulation/demodulation function for data transmission, a high-speed packet channel, coding function, a real-time modem control function, etc.

The base station may transmit data received from an upper layer to the terminal by wire or wirelessly. The base station may include a low-power RF/IF module. The base station may also include a means, a module, or a part for performing a control function to implement the embodiments of the present invention, orthogonal frequency division multiple access (OFDMA) packet scheduling, time division duplex (TDD) packet scheduling and channel multiplexing functions, a MAC frame variable control function adapted to service properties and propagation environments, a high-speed traffic real-time control function, a handover function, an authentication and encryption function, a packet modulation/demodulation function for data transmission, a high-speed packet channel coding function, a real-time modem control function, etc.

The present invention may be carried out in other specific ways than those set forth herein without departing from the spirit and essential characteristics of the present invention. The above detailed description is therefore to be construed in all aspects as illustrative and not restrictive.

The scope of the invention should be determined by reasonable interpretation of the appended, and all changes coming within the meaning and equivalency range of the appended claims are intended to be embraced therein. Claims that are not explicitly cited in the appended claims may be presented in combination as an exemplary embodiment of the present invention or included as a new claim by subsequent amendment after the application is filed.

### INDUSTRIAL APPLICABILITY

The embodiments of the present invention may be applied to a variety of wireless access systems. Examples of the wireless access systems include a 3GPP system, a 3GPP2 system, and/or an IEEE 802.xx (Institute of Electrical and Electronic Engineers 802) system. The embodiments of the present invention may be applied not only to the various wireless access systems but also to all technical fields to which wireless access systems are applicable.

1. A signal transmission method of a transmitter using multiple antennas, comprising:
a feedback information receiving step of receiving from a receiver a transmission rate and channel state information for signal transmission;
a step of generating a signal to be transmitted using the multiple antennas according to the transmission rate;
a step of performing precoding upon the generated signal using a precoding matrix of a nested structure selected from a predetermined codebook according to the transmission rate; and
a step of transmitting the precoded signal,
wherein the codebook includes a precoding matrix set in which a precoding matrix according to a first number of streams is not included in a precoding matrix according to a second number of streams which is greater than the first number of streams.

2. The signal transmission method of claim 1, wherein the feedback information receiving step comprises receiving feedback information further including a number of streams and channel quality information from the receiver.

3. The signal transmission method of claim 2, wherein the number of the streams is determined by the transmission rate, and when the transmission rate is 1, the transmission rate is equal to the number of the streams.

4. The signal transmission method of claim 1, wherein the precoding matrix of the nested structure is a precoding matrix in which a precoding matrix according to a first number of streams is included in a precoding matrix according to a second number of streams which is greater than the first number of streams.

5. The signal transmission method of claim 1, wherein the transmitter is a terminal and the receiver is a base station.

6. The signal transmission method of claim 1, wherein the transmitter is a base station and the receiver is a terminal.

7. A signal reception method of a receiver in a multiple antenna system, comprising:
a step of estimating channel information of a reception signal;
a feedback information transmitting step of transmitting a transmission rate and channel state information for signal transmission, based on the channel information of the reception signal to a transmitter; and
a step of receiving a precoded signal using the transmission rate and information of a precoding matrix of a nested structure corresponding to a number of streams in a predetermined codebook,
wherein the codebook includes a precoding matrix set in which a precoding matrix according to a first number of streams is not included in a precoding matrix according to a second number of streams which is greater than the first number of streams.

8. The signal reception method of claim 7, wherein the feedback information transmitting step comprises transmitting feedback information further including the number of streams and channel quality information to the transmitter.

9. The signal reception method of claim 8, wherein the number of the streams is determined by the transmission rate, and when the transmission rate is 1, the transmission rate is equal to the number of the streams.

10. The signal reception method of claim 7, wherein the precoding matrix of the nested structure is a precoding matrix in which a precoding matrix according to a first number of streams is included in a precoding matrix according to a second number of streams which is greater than the first number of streams.

11. The signal reception method of claim 7, wherein the precoding matrix of the nested structure is configured by selecting a column vector corresponding to the number of streams from a precoding matrix based on the feedback information in the transmitter.

12. The signal reception method of claim 7, wherein the transmitter is a terminal and the receiver is a base station.

13. The signal reception method of claim 7, wherein the transmitter is a base station and the receiver is a terminal.
